(19) United States
(12) Patent Application Publication
(10) Pub. No.: US 2019/0043020 A1
(43) Pub. Date: Feb. 7, 2019

(54) GENERATING AND ENHANCING MEETING-RELATED OBJECTS BASED ON IMAGE DATA

(71) Applicant: VERITEXT CORP., Livingston, NJ (US)

(72) Inventors: Anthony Donofrio, Woodcliff Lake, NJ (US); Jay Goldberg, West Orange, NJ (US); Michael Murray, Lake Forest, CA (US); Jonathan Kaplan, West Orange, NJ (US); Peter Baio, Plainfield, NJ (US)

(21) Appl. No.: 16/049,664

(22) Filed: Jul. 30, 2018

Related U.S. Application Data
(60) Provisional application No. 62/540,213, filed on Aug. 2, 2017.

(51) Int. Cl. G06Q 10/10; G06K 9/00; G06K 9/34

(52) U.S. Cl. CPC G06Q 10/1095; G06K 9/00979; G06K 2209/01; G06K 9/00469; G06K 9/00456; G06K 9/344

(57) ABSTRACT

Systems and methods are described for automated scheduling of a meeting, storing and enhancing meeting-related data objects, and providing meeting notifications to a number of participants. A computing system may obtain an image of a document in association with a meeting arrangement. Optical character recognition may be applied to the image data to identify text data represented in the image, from which meeting arrangement related information may be identified based at least in part on keyword analysis, pattern matching and/or natural language processing. Additional resources, participants or other information not explicitly identified in the image data may be determined based on various rules and/or data retrieved from one or more data stores. Meeting invitations may then be generated by the computing system and delivered to various determined participants or resource providers for the meeting.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims benefit of U.S. Provisional Patent Application Ser. No. 62/540,213, entitled “SYSTEMS AND METHODS FOR GENERATING MEETING ARRANGEMENTS INVOLVING MULTIPLE RESOURCES,” filed Aug. 2, 2017, which is hereby incorporated by reference in its entirety.

### BACKGROUND

While certain technological improvements, such as electronic calendars, have simplified the process of setting up a meeting relative to traditional manual processes, existing computerized processes still typically include substantial input from a human organizer and/or from one or more participants in the meeting. Also, the existing technologies are typically lacking when applied to organizing a meeting involving multiple participants and highly specific resources, such as an interpreter or other peripheral or supporting attendees. For example, arranging a meeting in existing systems often includes an individual initiating a meeting arrangement process by manually creating an electronic meeting invitation that is sent by email or similar manner to other participants who the organizer manually identifies to the system. As more participants and resources are needed for a meeting, such as for a deposition in a legal proceeding, the arrangements of such meetings may get exponentially complex. As one example, existing deposition scheduling services often include an individual (such as an employee of a law firm) providing various information to the service through a question and answer process over the telephone, or by completing web-based forms that ask the individual to provide explicit indications of the date, location, participants and services required for the deposition.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 is a flow diagram of an illustrative method for retrieving meeting-related information from a physical document and, based on the information retrieved from the document, organizing a meeting with any necessary resources.

FIG. 2 illustrates an example client mobile device interface that provides ready access for various functionalities of the disclosed embodiments.

FIGS. 3A and 3B illustrate example mobile device interfaces in which a document having meeting request information, such as a deposition notice, is captured by the mobile device.

FIGS. 4A and 4B illustrate a meeting request document, such as a sample deposition notice, containing various meeting-related information, from which portions of meeting information can be determined following an optical character recognition (“OCR”) process.

FIGS. 5A and 5B illustrate example interfaces containing various information regarding the meeting arrangement.

FIG. 6 illustrates an example mobile device interface that includes suggestions of a meeting site based on the information gathered.

FIG. 7 illustrates a system block diagram of a computing environment suitable for use in various embodiments of the present disclosure.

### DETAILED DESCRIPTION

Generally described, aspects of the present disclosure relate to systems and methods to facilitate meeting scheduling and organization where there are multiple participants and a potentially complex set of meeting resources to be utilized in the meeting. Aspects of the present disclosure further include systems and methods to obtain a basic set of information from a meeting request document, and intelligently further obtaining related resources in an automated manner. Aspects of the present disclosure provide a fast, flexible, and intuitive system that integrates various aspects of a meeting arrangement and facilitates easy management of complex meetings while decreasing the burden on the party responsible for arranging the meeting. In addition, fewer user interfaces or webpages may be presented to a meeting organizer relative to prior art systems, reducing the number of network requests made by a client computing system and requiring fewer selections or actions to be made by the user in arranging a meeting and notifying related parties.

As more participants and resources are needed for a meeting, the arrangements of such meetings may get exponentially complex. For example, finding an available time for two participants could be relatively easy. However, finding an available time between five different people is significantly more difficult. Additionally, some meetings like business meetings may require audiovisual records of the meetings or other supporting materials, other equipment or support personnel, further confounding the difficult task of managing availability among participants and resources. Another level of complexity is introduced when a subset of participants are interchangeable, such as a meeting that requires a person having a specific role or function (such as a videographer, court reporter or translator), but where a number of potential parties could be placed in the meeting to fulfill that role.

This difficulty becomes particularly pronounced when a meeting is of high importance yet requires attendance of parties having interpersonal conflicts. One example of such a meeting is a deposition of a witness in a legal proceeding, such as litigation case. While a deposition requires cooperation and collaboration, the underlying circumstances may be hostile. A witness to the deposition may not wish to be deposed. Additionally, a deposition may require attendance of a court reporter for facilitating the creation of transcripts, an interpreter for a witness who does not fluently speak English, and/or some recording device (and potentially an associated camera operator) at the deposition site.

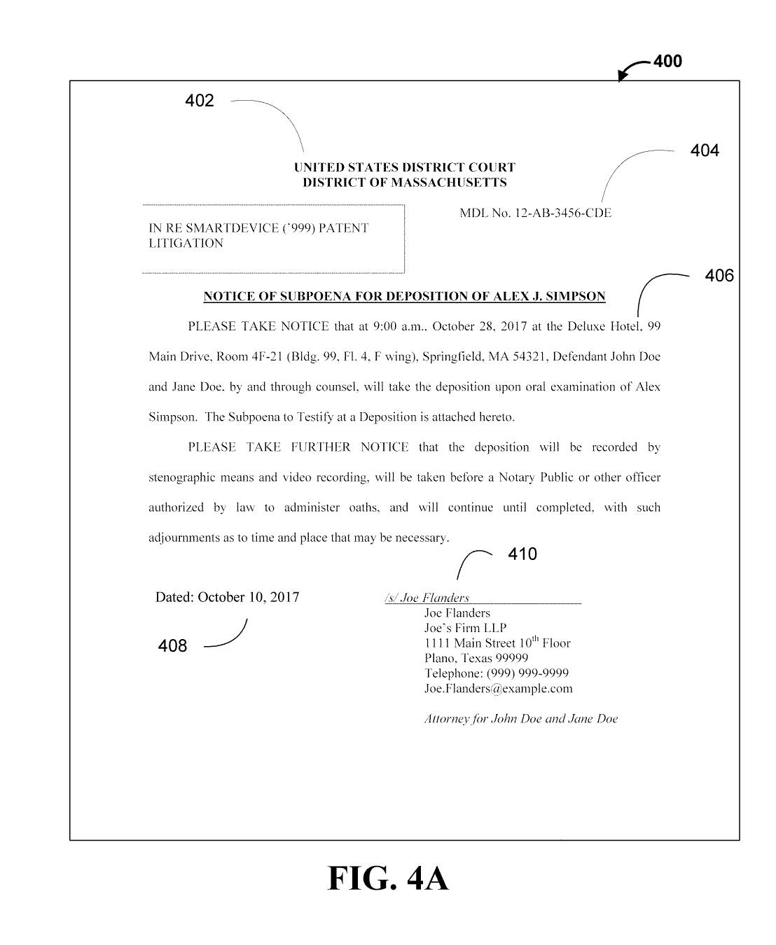

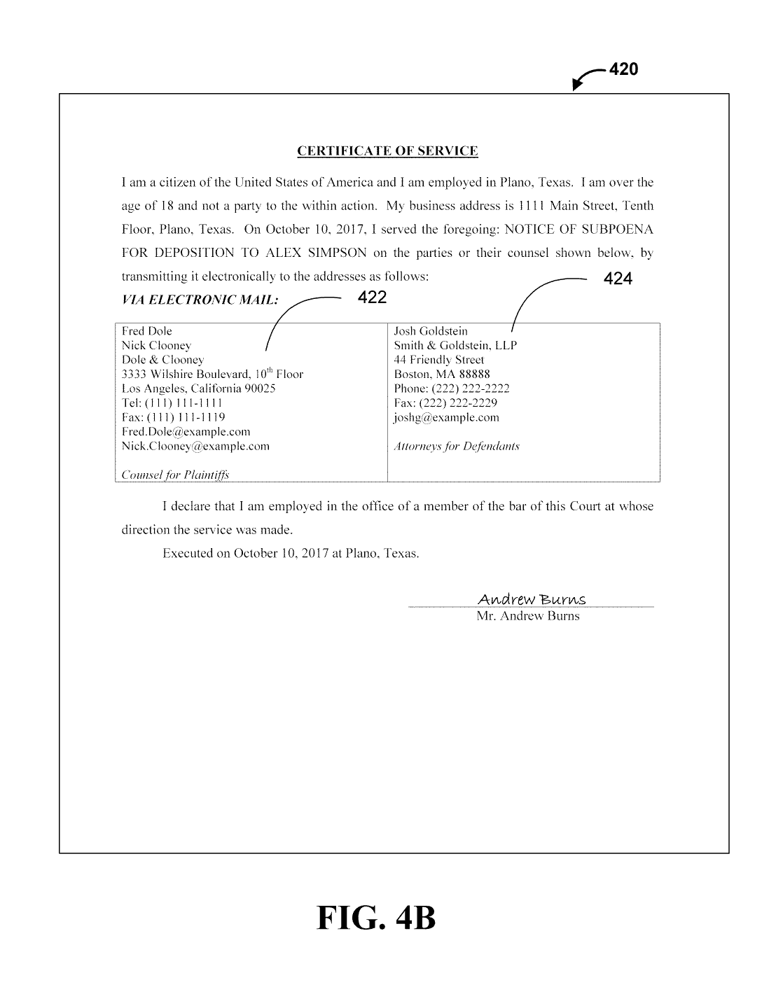

A typical existing process of scheduling a deposition involves one of the parties (such as an attorney taking the deposition) identifying all the resources that will be needed for the deposition, picking and choosing a time and site after conferring with the opposing party (such as counsel for the witness being deposed), contacting one or more resource vendors (such as a court reporting service or an interpreter), and requesting access to those resources for the deposition time and site. Before or after performing some of these steps, the deposing attorney would typically draft a deposition notice which may look similar to FIG. 4A (in some instances) and serve the notice to a witness. A paralegal or an assistant would then typically manually enter all the deposition information and manage responses from any participants or resources. Often the deposition is later postponed or canceled, creating a communication and record-keeping nightmare. According to such typical existing procedures, all the resources such as court reporters and interpreters may then need to be informed of the changed schedule and the records may need to be updated manually (potentially resulting in changes to which support personnel or other attendees will be available).

Managing multiple participants and resources while observing all the required formalities may leave many aspects of the scheduling to human error. For example, mistyping the opposing counsel's email address for the deposition notice could result in an unnecessary delay of the deposition. Schedulers sometimes fail to update or maintain the scheduling in a timely manner, which results in last-minute changes or cancellation of the meeting. Even if participants are present, if a necessary resource, such as interpreter, was not obtained or is found to be less than satisfactory, a valuable time and resource may be lost. All the participants should be notified of any proposed reschedule, which also may not be a simple task. Accordingly, current scheduling methods are slow, reliant on significant data collection from one or more participants or their representative (which is thus prone to human error), and often inflexible upon encountering scheduling conflicts.

The systems and methods disclosed herein seek to greatly simplify these tasks. As it will become evident throughout the disclosure, the scope and reach of the present application and the disclosed embodiments are not limited to a deposition setting. However, because the deposition notice setting is highly complex yet of high importance, scheduling a deposition is often used herein as an illustrative example to provide context that facilitates the disclosure of numerous aspects and the advantages of various embodiments. It will be appreciated that the meetings or other scheduled events referenced herein may extend beyond meetings related to legal proceedings or similar settings, and that aspects of the present disclosure provide utility in scheduling or arranging multi-participant meetings of a variety of types.

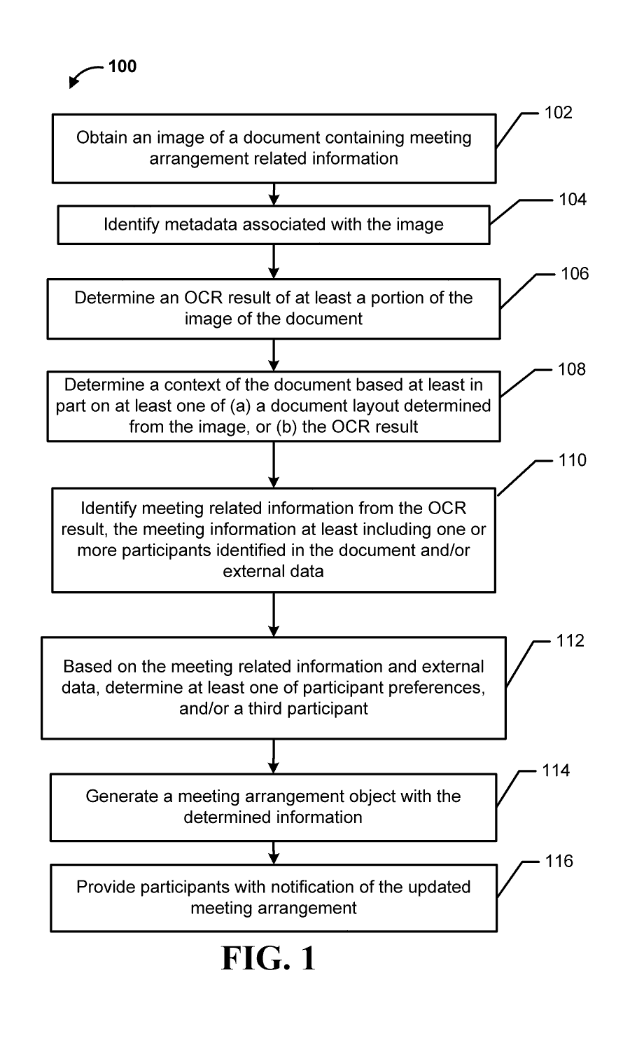

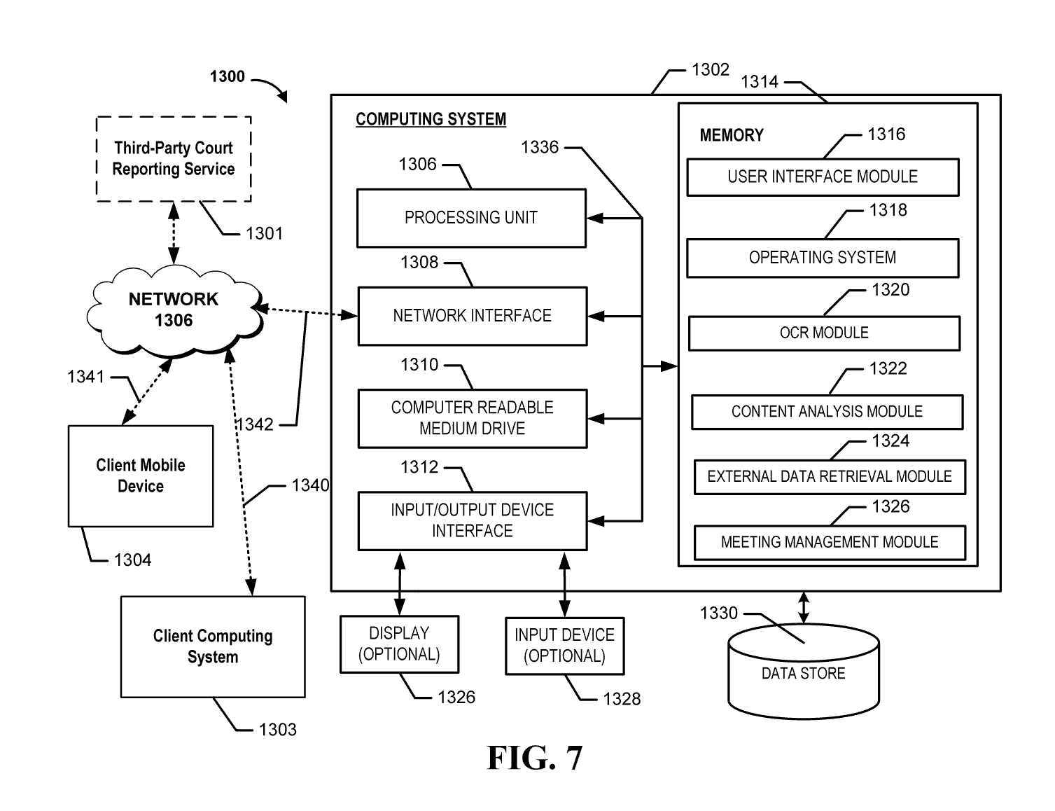

FIG. 1 is a flow diagram of an illustrative method 100 for retrieving meeting-related information from a physical document (or digital image representation of a document) and, based on the information retrieved from the document, organizing a meeting with necessary resources. The illustrated method is implemented by a computing system, such as the system further described in relation to FIG. 7 below. The method 100 begins at block 102, where the computing system obtains an image of a document with one or more printed text portions providing meeting arrangement related information. The image of the document may be of a compressed or uncompressed image file type such as JPEG, PNG, BMP, or any other type of image files. In some embodiments, the image may be a raster graphic or a vector graphic.

The computer system may obtain the image file by directly accessing a memory device or data store where a pre-existing image is stored, or the image may be obtained in real-time through a camera-like device or over a network. In some embodiments, the computer system may obtain an image of a document from a web browser and/or a client application, where an image file of the document may be dragged-and-dropped via a graphical user interface to a pre-identified location of the web browser or other client application in order to load the image to the system (e.g., send the image from a client device over a network). In another embodiment, a client application operating on a mobile device (such as a mobile phone) of a user may capture the image via a camera of the mobile device, and may automatically send the image to the computer system over a network (such as the Internet) for analysis in response to executing code of the application.

Referring to block 104, once the system has obtained the image of a document containing meeting arrangement related information, the system may optionally proceed to identify any metadata associated with the image. Some of the metadata associated with the image may include author information, image creation timestamp, and/or image creation location (such as geographic location information indicating where a photograph of the document was captured, which may have been automatically added as metadata to an image file by a digital camera device). In some embodiments, the metadata may also include image access privilege, modification history (including who and when), and indication of an original or a duplicate. Such metadata may be used by the computing system to determine some missing information later. For example, where a document is missing a service date, the date of the image creation may replace or populate the service date in a record. As another example, where an image of a document was created and uploaded by someone without permission to the computer system (or not authorized to act on behalf of an account holder having an account maintained by an associated scheduling service), the system may create a meeting object with populated fields, but then forward it to someone who supervises the uploader or who otherwise has proper authority to approve the meeting.

At block 106, the system may perform OCR on the image in order to transform the image that is typically not machine-searchable (in terms of text searches) into a machine searchable document that includes text data. In some embodiments, the system may apply OCR on the entire image, while in some other embodiments the system may perform OCR on a portion of the image. Because there is a possibility that the OCR result may or may not perfectly accurately reflect the content contained within the document image, the system may further post-process the OCR result with a spellchecker, grammar checker, or generally compare with any stored information to improve upon the quality of OCR. In some embodiments, the system may employ more than one OCR processing algorithm to generate more than one OCR result, then compare and contrast the two results to identify any characters that require further correction.

As an example of an incorrect OCR result, the system may have identified a correct e-mail address for an attorney, but the wrong name. When the system identifies that the attorney's name substantially but not exactly matches an attorney name associated with the e-mail address, the system may correct the attorney's name or the e-mail address. In the example, the system may retrieve information from the user's contact list or e-mail correspondences, confirm the e-mail address, and proceed to correct the attorney's name. Alternatively, if there were no e-mails in the record that matches the OCR-determined e-mail address but there is a substantially matching e-mail address, then the system may correct the e-mail address to the substantially matching e-mail address. In other embodiments, a list of potentially matching or partially matching names and/or email addresses for comparison to the OCR results may be retrieved from a server or network data store that stores various information regarding participants from past meetings. For example, the system may retrieve a list of attorneys who have utilized a given deposition scheduling service in the past or who are admitted to practice before a given court or in a given jurisdiction.

In some embodiments, the system may identify a portion of the document that contains a physical address. For example, upon identifying a five digit number with the OCR result, the system may assume that the number is a ZIP Code and proceed to analyze the text preceding the five digit number as a physical address. Once it identifies one or more possible candidates for physical addresses, the system may compare the addresses to an internal or external geographical mapping service database, and retrieve a standardized address, including replacing any non-standardized or misspelled addresses.

At block 108, a context of the document may be determined from (a) a document layout determined from the image, and/or (b) the OCR result. For example, the context may indicate that the notice is for a civil or criminal proceeding, possibly requiring different types of participants and/or resources. For example, where it is a criminal proceeding, criminal code may require that a suspect be provided an opportunity to confront a witness in person. However, in other types of proceedings, rules may be different and require a video recording. The context of the litigation encompassing a deposition may thus be highly relevant in setting up a deposition.

Drawing upon a database or a set of rules categorizing types of cases, the system may further determine that a civil proceeding is for a small claim, limited/unlimited claim (such as in California), at a state court or a federal court, and/or other can be otherwise categorized. Where a document may not specifically point out which parties deposition participants belong to, a document layout may be informative. For example, if there is a court rule regarding the layout of the document, such as plaintiff's counsel goes left or first, then the system may determine, based on the layout of the document, which participant belongs to which side. Additionally, once the context of the document has been determined, the system may identify a related date, such as a deadline to respond by, and make a note for arranging the deposition. Accordingly, the context information may be a valuable resource in management of meeting resources. The given rule set used in a given instance may be specific to a certain court, jurisdiction, type of proceeding, client, or other factors determined at least in part from the automated analysis of the document image.

At block 110, the system may also identify additional meeting-related information from the OCR result, such as one or more additional participants to the meeting. For example, the identity of a deposed witness, particular court information, case docket number, deposition site, notice date, noticing attorney, and counsel for plaintiff or defendant may be identified, among other fields. The meeting-related information may be obtained from keyword analysis, pattern matching, and/or natural language processing of the text data in the OCR result.

For example, keyword matching could be used to search for words of months, such as January or February. After finding a matching month, the text in the vicinity of the month may be retrieved and analyzed with the pattern matching to identify the time of the deposition. One such pattern may be “MONTH followed by ##, ####,” where #s represent some number. Another pattern to identify a date may be “##/##/####.” Similarly, identifying a meeting time may also utilize a pattern, such as by identifying a colon with one- or two-digit numerals on both sides of the colon. Such a pattern may readily recognize a time stamp, such as 9:30 a.m., to identify a meeting-related timestamp from a deposition notice. In some instances, identifying words such as “video” or “conference call” may indicate the need for a certain type of resource, such as a camera, court reporter and/or videographer.

In certain embodiments, the system may use natural language processing by itself or in combination with other techniques to determine an additional participant or some other meeting-related information. For example, in determination of which party is a witness and which parties are attorneys, a rule set may be configured to identify that a name that follows “depose” is likely to be a witness (e.g., from the text “Ned will depose Alex,” the system may determine that Alex is a witness), while the grammatical subject of “depose” would be a deposing party (Ned is the deposing party). On the other hand, the parties may be the opposite according to a related rule when text includes a slightly different wording such as “deposed by.”

These text analysis techniques and/or other techniques may be employed in association with a deposition notice in order to glean meeting-related information from the OCR result. In some embodiments, the gleaned information may be readily used in setting up a meeting. In some embodiments, the information may be compiled and stored in a database for future comparison and verification purposes.

At block 112, based on the meeting-related information identified in the aforementioned blocks, the system may proceed to identify additional meeting-related information. One type of such information is resources, including both human resources and technological resources. For example, when deposing a witness whose primary language is not English, an interpreter who is versed in the witness's language may be needed at the scene of deposition. Here, the system may retrieve data from an internal or external database in order to further identify the witness's nationality. For example, if a witness has a certain last name that is often associated with a certain ethnicity, such as Kim for Koreans, or Nakamura for Japanese, then the system may relate those last names with a certain language interpreter. This name recognition and language association in combination with a keyword appearance in the OCR results such as “interpreter” (without necessarily explicitly identifying the language of the interpreter in the OCR results) may enable the system to narrow the specific resources to assign to a meeting (e.g., from interpreter to Korean interpreter) that were initially identified from a keyword in the text.

In some embodiments, the system may search for the witness's name in past records and upon finding any records, determine if an interpreter was used in a past deposition or other meeting. Alternatively, even if there are no past records, the system may consult with an external database via a third-party API or similar access points to make the same determination. Upon identifying a possible need for an interpreter, the system may store an indication of the human resource to be included in association with the deposition or other meeting. In some embodiments, the system may, before setting up a deposition time, access an internal calendar of each of a number of different interpreters' available times or an external interpreter service calendar (via API or similar access points) and suggest a deposition to be made at a time when there is an available interpreter, thereby preemptively removing possible scheduling conflict. In some other embodiments, a meeting time may be setup first and the system may then crawl interpreter services to find a suitable interpreter who is available at that time (e.g., searching internal calendars and/or querying third party interpreter providers via an API). Similarly, an availability of a court reporter, another type of human resource, may be consulted before or after a deposition setup in a similar manner.

An example of a technological resource may be video recording equipment or a conference call facility. Similarly, when the system determines that video recording equipment is needed, the system may automatically determine availability of the equipment based on data in one or more data stores and propose a suitable meeting time and site.

With respect to additional participants, the system may look up (in a data store internal or external to the system) an attorney's name who is associated with a deposed witness, thereby identifying a third participant for the deposition. Additionally, information such as the identified case docket number, the opposing counsel names, or the combination of both may be used to look up past deposition transcripts and exhibits. The system may analyze such past documents that are related to the case and identify additional information from those documents. For example, the past transcripts may contain information about the witness's guardians, conservators, agents, principals, or other types of proxies. Upon identifying the proxies, the system may then retrieve contact information of those proxies and include them as participants where necessary. It should be noted that some human resources, such as an interpreter or a court reporter, may also at times be considered as meeting participants instead of resources. Additionally, a resource, such as a video camera, may require an associated participant (e.g., a videographer), or vice versa.

At block 114, the system generates a meeting arrangement object with all the retrieved and/or determined information. In one embodiment, the system may create the meeting arrangement object and populate various fields with the determined information. In some embodiments, a user of the system may be provided with an opportunity to review the meeting arrangement and may modify details as she deems appropriate. In other embodiments, the system may not include any human review or human input after the system receives the image of the document before a meeting invitation with full meeting details is automatically sent by the system to one or more of the participants.

The meeting arrangement object may be stored and formatted in a number of ways depending on the embodiment. In some embodiments, the object may be of an enumerated data type defined for the specific meeting type (e.g., deposition of an expert witness, deposition of a fact witness in a criminal proceeding, etc.), which may define a number of fields each having an associated data type (e.g., string, Boolean value, integer, date, etc.). In some embodiments, individual fields or components of the object may point to other objects or entries in a database. For example, the meeting arrangement object may include pointers or references to a record for a participant (e.g., a record including the participant's contact information, preferences, etc.), a resource, a meeting location, etc. It will be appreciated that the object's data may be stored or represented within a relational database or non-relational database, among other storage options. In other embodiments, the object's data may be only temporarily stored in order for the system to use that information to populate fields in meeting invitations and/or calendar entries for the participants, resources and optionally an organizer or system administrator calendar.

The meeting arrangement object may contain contact information, such as email addresses and/or phone numbers, which may be used by the system for sending out appropriate notifications to the participants, as shown in block 116. In some embodiments, the notification(s) at block 116 may be sent by email, a private web-accessible inbox associated with a deposition scheduling service, a push notification, an SMS message and/or an in-application message within an application associated with a deposition scheduling service. The notification may include a calendar invitation formatted for one or more third-party calendar applications, such that each participant may add the deposition or other meeting to his or her personal electronic calendar. A confirmation message or interface provider to an organizer of the meeting may include additional information, such as a tracking number used to identify the meeting with a deposition scheduling service, a list of scheduled services (such as a court reporter, videographer, real-time transcripts, etc.), options to cancel or change the booking, etc.

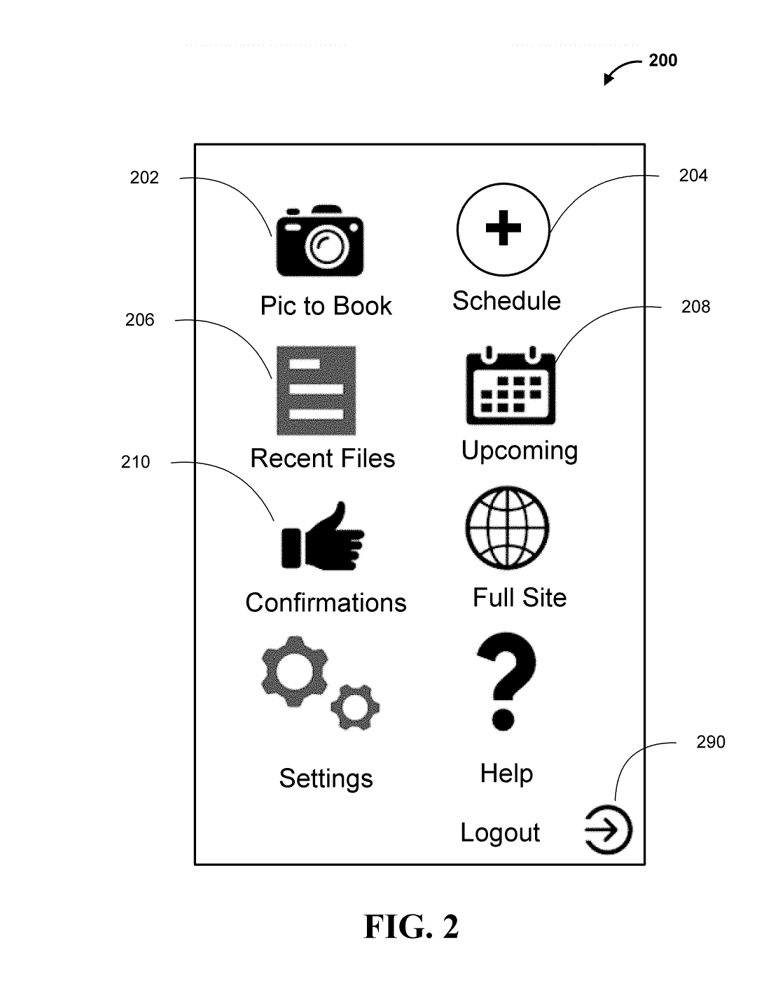

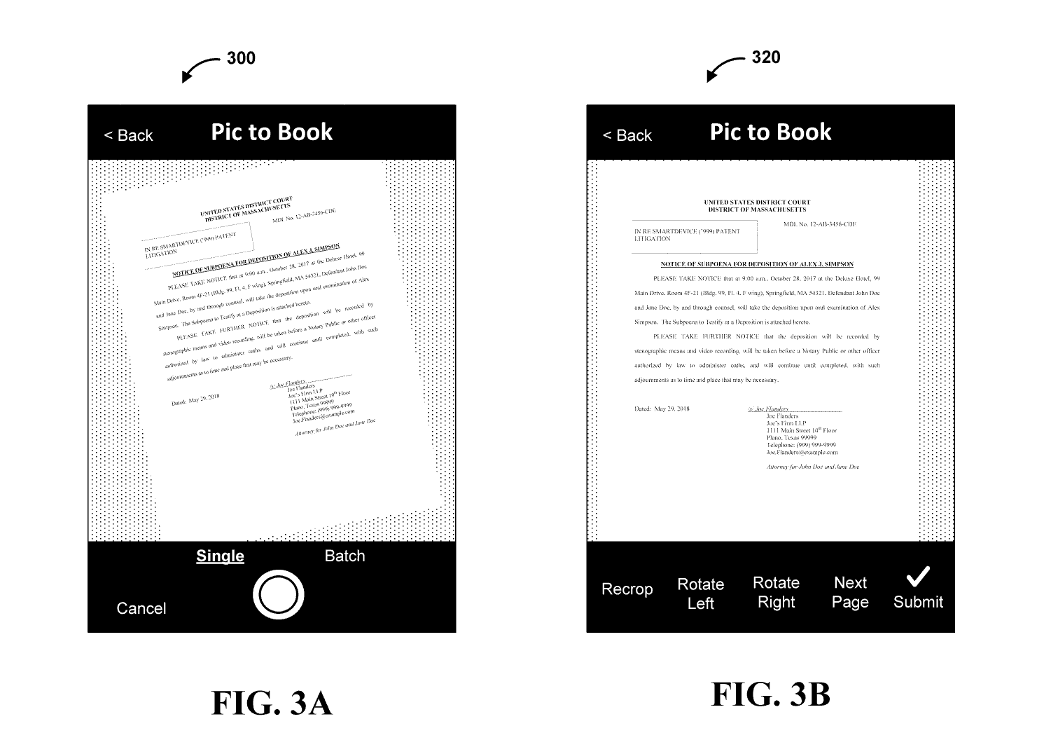

FIG. 2 illustrates an example client mobile device interface 200 that provides ready access for various functionalities of the disclosed embodiments. The illustrated user interface 200 may be generated by a computing system for display on the display of a mobile device, such as a mobile phone or tablet computer, in some embodiments. The interface 200 provides icons representing various selectable options. For example, the picture to book icon 202 is operably associated with a mobile device's camera such that pressing the button may launch a camera access interface, such as that shown in FIG. 3A. With the icon 202, a user may provide the system with an image of a document. This functionality provides one way in which the system may implement at least a portion of block 102 in FIG. 1 (with at least one other way being where the system may access an existing image from a data store). The schedule icon 204 provides for manual entry of a meeting arrangement.

In some embodiments, where the user has logged in and is verified (the user having logged into an account being indicated by a display of the logout button 290 in FIG. 2), the user may have access to related documents such as transcripts and/or exhibits from previous depositions. Those other documents may be accessed through the recent files icon 206. A verified user may access upcoming meeting arrangements through upcoming icon 208 or confirm meeting requests and modifications via the confirmations icon 210.

FIGS. 3A and 3B illustrate example mobile device interfaces 300 and 320 in which a document having a meeting request information, such as the deposition notice, is loaded into a mobile device. These interfaces may be presented on a display of the mobile device by an application executed by the mobile device, in one embodiment. As shown in FIG. 3A, a user may access the mobile device's camera through the pic to book icon 202 (shown in FIG. 2) and capture an image of a physical document. For example, the interface 300 as illustrated includes a live camera view of a physical deposition notice (e.g., as printed on a piece of paper currently on top of a desk in front of the mobile device's camera lens), which the user may capture as a digital image via the interface 300. Once the image is captured, the system may identify the edges of the document in the image, resize and rotate such that only the portion of the image that captures the physical document remains visible of the original image. In some embodiments, the system may automatically identify the edges of the document and crop, transform, and/or adjust the image data so that the process of preparing the image for an OCR process is automatic.

In some embodiments, as shown with FIG. 3B, a user may be shown a visual representation of the image before it is sent through OCR processing, and further edit—crop, rotate, expand, or contract the image. Once a user is satisfied with the image, the user may submit the image of the document for an OCR processing as described with respect to block 106 of FIG. 1. In some embodiments, the submission may be automatic with the system receiving the OCR result and analyzing the document to determine whether it contains any meeting information. For example, in one embodiment, the user may simply select an icon to indicate that the image should be captured by the camera, and the next input asked of the user may be to confirm the resulting meeting information discussed with respect to blocks 114 and 116 above (e.g., information beyond the text of the document may be presented for confirmation, such as additional resources derived or determined from text of the document captured as an image).

As will be described with respect to FIG. 7 below, the OCR process may be performed at a client mobile device, client computing system, or a server computing system. A person skilled in the art would understand that the OCR process may be performed at any of the above, or even some other external processing computing device providing an OCR process. In other embodiments, the OCR process may be outsourced to a third party OCR service, provided the confidentiality of the document is protected.

FIGS. 4A and 4B illustrate pages of a meeting request document 400 and 420 (which may have been obtained by the computing system in image form via a camera capture interface similar to FIGS. 3A and 3B discussed above). The document 400 and 420 may be a sample deposition notice, containing various meeting-related information, from which aspects of the present disclosure may obtain the information based in part on an OCR process. The presiding court 402 is often at the very top of the document (as illustrated), though in other instances may follow header information identifying a law firm or attorney. Relying on the layout of the document (e.g., by comparing an apparent format of the document to stored templates of potential expected formats, such as using pattern matching), or often the nature of having bold characters, the system may recognize the name of the court. In some embodiments, identifying the word “court,” or a state name such as Massachusetts or finding United States in vicinity, the system may have higher confidence in its recognition of a court name. The case docket number 404 may provide the court name, parties' names, status of the case, and other contextual information regarding the particular deposition notice. Accordingly, the system may, by the case number itself or the case number in combination with other information, access one or more internal or external databases and obtain additional contextual or meeting-related information. Some other meeting-related information may be identified from the deposition notice as well. In the sample deposition notice of FIGS. 4A and 4B, the site of the deposition 406, the date of the notice 408, the signing attorney information 410, plaintiffs' attorney information 422, and defendants' attorney information 424 are available. It should be noted that the sample deposition notice (as well as associated Certificate of Service 420) is used for illustrative purposes and is not to be considered limiting in the variety of meeting-related information that a document may contain.

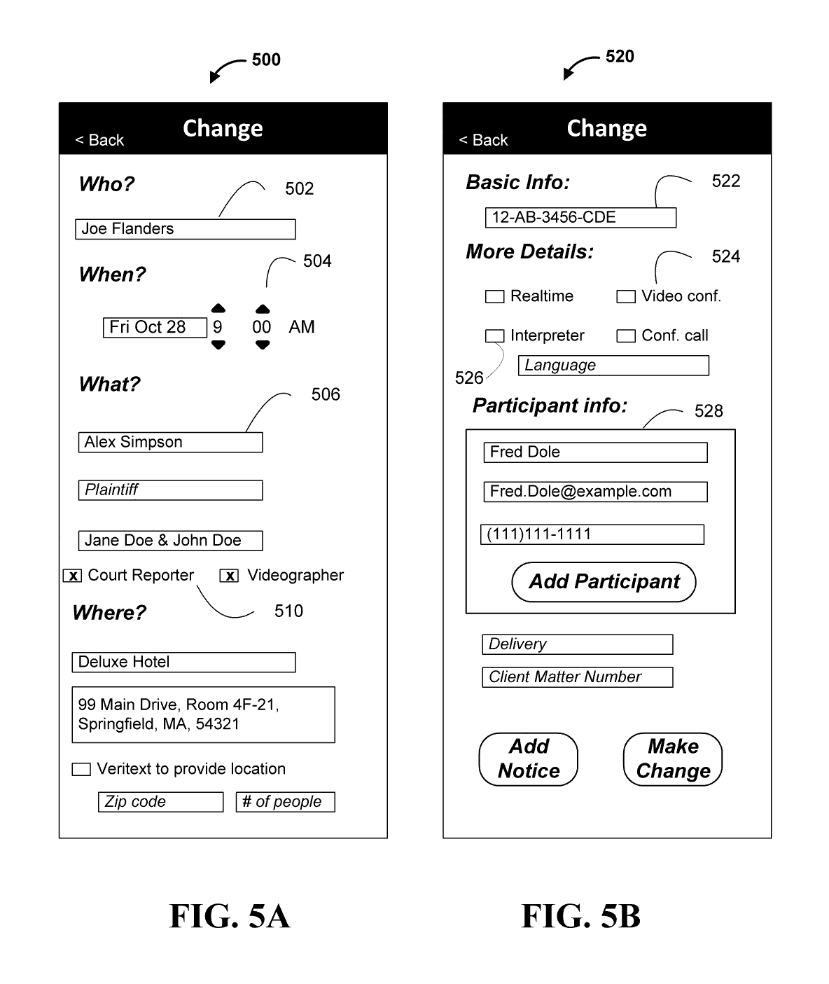

FIGS. 5A and 5B illustrate example interfaces 500 and 520 containing various information regarding a meeting arrangement, such as a deposition, determined from an image. From the OCR'ed image of the sample deposition notice in FIGS. 4A and 4B, FIGS. 5A and 5B illustrate that the system has determined various information including the attorney who has drafted the deposition notice 502, the proposed deposition time 504, the name of the witness 506, whether a court reporter may be needed 510, the case docket number 522, various types of resources for the deposition such as videoconferencing 524 or need of an interpreter 526, and additional participant(s) 528 (such as attorney Fred Dole). While much of the necessary information may be contained within a deposition notice, some information, such as the need for videoconferencing facility 524 and interpreter 526 may not be readily available from the deposition notice, in certain instances. Such additional information, as described with respect to block 112 of FIG. 1, may be obtained from accessing internal or external data sources for any records that indicate usage of the resources in the past. As also described, keyword matching, pattern matching, and/or natural language processing may be used on some retrieved data such as the witnesses last name indicative of a certain ethnicity, and suggest a specific type of resource such as a Korean-speaking interpreter.

Additionally, if available from the case number, type of court, layout, or any other information that provides the case context, a resource such as video recording facility may be identified. For example, where a witness is a victim of a rape, and where a jurisdiction allows for a victim to testify without having to confront a suspect, an accurate context identification of the case from the deposition notice may suggest the use of a video recording device. With the information, the system may create a meeting object and automatically populate some or all of the fields with the identified information. For example in the illustrated interface, the system has populated at least the time 504 from the sample deposition notice in FIGS. 4A and 4B without user input beyond submitting an image of the deposition notice. In some embodiments, the information such as that displayed in user interfaces 500 and 520 may presented in an editable form to the user in case the user would like to make changes to one or more field values that were automatically determined by the computing system based on the image.

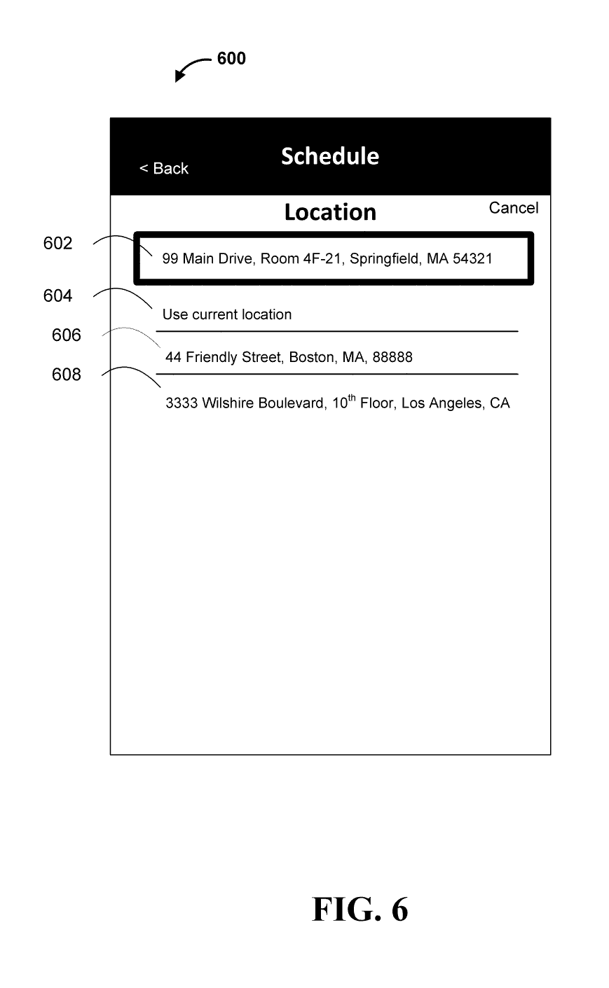

FIG. 6 illustrates an example mobile device user interface 600 that includes suggestions of a meeting site determined by a computing system based on the information gathered from an image of a deposition notice or other document. Based on the sample deposition notice in FIGS. 4A and 4B, the system may make suggestions for a meeting site. For example, the sample deposition notice in FIG. 4A serves witness Alex Simpson to a deposition on Oct. 28, 2017 at 9:00 AM at the Deluxe Hotel located at 99 Main Dr., room 4F-21. Using keyword search, pattern matching, and/or natural language processing, the system identifies some phrases that denote a physical addresses, such as the address of the Deluxe Hotel (as address 602), plaintiff attorney's office 606 (as determined from address 424 in FIG. 4B), and defendant attorney's office 608 (as determined from address 422 in FIG. 4B). The system may also provide for quick access to updating the meeting site with a current location 604 as determined by a GPS possibly electrically connected to or incorporated within a mobile device that presents the user interface 600 for display. Here, the system has automatically populated the data field with the correct deposition site 602 (as analyzed and determined automatically from an image) and is offering an easy modification of the site field by giving the lists of physical addresses 606 and 608 as potential deposition locations. Additional locations presented in such an interface may be, for example, past deposition sites known to the system and retrieved from a data store (e.g., hotels, conference centers, law offices, etc. located geographically near to an address or city name extracted from a deposition notice image or similar image).

A computing system as described herein may provide other features, such as features related to deposition support and scheduling services. For example, a user interface may provide access to a calendar containing past, present, or future meeting information, and/or a searching capability for searching and filtering of a specific set of meetings. In some embodiments, a user may search for a previously scheduled deposition or other meeting by providing one or more of witness name, case name, and/or keyword search. In addition, a computing system may generate and present webpages that include form input fields (such as attorney name, deponent name, etc.) that are pre-populated with data extracted from an image or file containing a deposition notice, potentially without having prompted a user to manually enter information (e.g., based on input of an image file alone without receiving explicitly entered meeting information). For example, in addition to or instead of accessing the system through a mobile device interface operating on a mobile device, as discussed above, the system may provide access via a web browser or a client application operating on other types of devices (such as a desktop computer). Such an interface may provide drag-and-drop functionality for submitting a deposition notice or other meeting request document (such as an image file, PDF document or other formatted document) having content similar to that shown in FIGS. 4A and 4B. The system may then perform an OCR processing (or other text extraction process appropriate for the document file type) on the document and perform automatic population of a meeting object as discussed above.

Upon successful scheduling of the meeting, a meeting request and its related information may be automatically generated and provided to the participants via e-mail, SMS, traditional mail, and/or other communication methods. In some embodiments, the system may track the meeting notifications and follow-up with participants or resources that have accepted or are available, respectively. In some embodiments, the system may provide easy access to various actions regarding modification, cancellation, sharing, printing, rebooking, or other commands. In association with a deposition scheduled via the computing system, the system may provide access to transcripts, exhibits, or other documents that may easily be accessed via a web browser or a client application.

FIG. 7 illustrates a system block diagram 1300 of a computing environment suitable for use in various embodiments of the present disclosure. As depicted in FIG. 7, the computing environment 1300 may include a computing system 1302. The general architecture of the computing system 1302 may include an arrangement of computer hardware and software components used to implement aspects of the present disclosure. The computing system 1302 may include many more (or fewer) elements than those shown in FIG. 7. It is not necessary, however, that all of these generally conventional elements to be shown in order to provide an enabling disclosure. In some embodiments, the computing system 1302 may be an example of what is referred to as the server or meeting arrangement system above (or sometimes simply referred to above as the computing system).

As illustrated, the computing system 1302 includes a processing unit 1306, a network interface 1308, a computer readable medium drive 1310, an input/output device interface 1312, an optional display 1326, and an optional input device 1328, all of which may communicate with one another by way of a communication bus 1336. The processing unit 1306 may communicate to and from memory 1314 and may provide output information for the optional display 1326 via the input/output device interface 1312. The input/output device interface 1312 may also accept input from the optional input device 1328, such as a keyboard, mouse, digital pen, microphone, touch screen, gesture recognition system, voice recognition system, or other input device known in the art.

The memory 1314 may contain computer program instructions (grouped as modules or components in some embodiments) that the processing unit 1306 may execute in order to implement one or more embodiments described herein. The memory 1314 may generally include RAM, ROM and/or other persistent, auxiliary or non-transitory computer-readable media. The memory 1314 may store an operating system 1318 that provides computer program instructions for use by the processing unit 1306 in the general administration and operation of the computing system 1302. The memory 1314 may further include computer program instructions and other information for implementing aspects of the present disclosure. For example, in one embodiment, the memory 1314 may include a user interface module 1316 that generates user interfaces (and/or instructions therefor) for display upon a computing system, e.g., via a navigation interface such as a browser or application installed on the computing system 1302 or the client computing system 1303.

In some embodiments, the memory 1314 may include an OCR module 1320 that the processing unit 1306 may execute in order to convert an image of the document into a computer readable text-based document. While an OCR module 1320 is illustrated in FIG. 7 as residing within the memory 1314 of the computing system 1302, a client mobile device 1304 other type of a client computing system 1303 may alternatively or additionally include an OCR module, in some embodiments. For example, depending on the embodiment, an OCR process may be performed by a server (such as computing system 1302) that receives an image or image-based file over the network 1306 from client mobile device 1304 or client computing system 1303, or an OCR process may be performed by an OCR module within an application operating on the client mobile device 1304.

In some embodiments, the memory 1314 may include a content analysis module 1322 and an external data retrieval module 1324, which may be executed by the processing unit 1306 to perform operations according to various embodiments described herein. The content analysis module may implement various aspects of the present disclosure described above, such as keyword matching, pattern matching, natural language processing, and others. The modules 1322 and/or 1324 may access the data store 1330 in order to retrieve data described above and/or store data such as comparing an identified name of a person to a contact list in the data store in order to verify or correct the identified name. The data store may be part of the computing system 1302, remote from the computing system 1302, and/or may be a network-based service 1301. For example, as described, the external data retrieval module 1324 may interface with a third-party court reporting service 1301 API in order to retrieve availability of any reporter, or a specific reporter who matches desired traits for a given meeting. The data store 1330 may store account information and various meeting-related information, such as contact lists, schedules, related documents, available resources, and other data for facilitation of a meeting arrangement.

In some embodiments, the meeting management module 1326 may provide creation of meeting object, population and modification of meeting information, and notification to the participants. The processing unit 1306 may apply various rules to identify conflicts between participants and resources, if any, and informs the users of viability of a proposed meeting. Where a meeting is not viable, the module may suggest one or more alternate viable meeting arrangements.

In some embodiments, the network interface 1308 may provide connectivity to one or more networks or computing systems, and the processing unit 1306 may receive information and instructions from other computing systems or services via one or more networks. In the example illustrated in FIG. 7, the network interface 1308 may be in communication with a client computing system 1303 via the network 1306, such as the Internet. In particular, the computing system 1302 may establish a communication link 1342 with a network 1306 (e.g., using known protocols) in order to send communications to the computing system 1303 and/or client mobile device 1304 over the network 1306. Similarly, the computing system 1303 and/or client mobile device 1304 may send communications to the computing system 1302 over the network 1306 via a wired or wireless communication links 1340 or 1341.

In some embodiments, the computing system 1302 may additionally communicate via the network 1306 with optional third-party court reporting service 1301, which may be used by the computing system 1302 to retrieve resource availability data to be delivered to a client computing system 1303 and/or client mobile device 1304, or to be added to a meeting object. Depending on the embodiment, the computing system 1302 may be configured to retrieve resource availability data from either data store 1330 or third-party court reporting service 1301 depending on various information, such as geographic proximity, quality of service, cost information, turnaround time, and/or other factors. While FIG. 7 depicts only third-party court reporting service 1301, one skilled in the art would appreciate that various aspects of the present disclosure may include the computing system 1302 connecting and using other third-party services, such as OCR services, court docketing systems, translation services, third-party calendar applications, etc.

Those skilled in the art will recognize that the computing systems 1302, 1303, and 1304 may each be any of a number of computing systems including, but not limited to, a laptop, a personal computer, a personal digital assistant (PDA), a hybrid PDA/mobile phone, a mobile phone, a smartphone, a wearable computing device, an electronic book reader, a digital media player, a tablet computer, a gaming console or controller, a kiosk, an augmented reality device, another wireless device, a set-top or other television box, one or more servers, and the like. The client computing system 1303 and client mobile device 1304 may include similar hardware to that illustrated as being included in computing system 1302, such as a display, processing unit, network interface, memory, operating system, etc., in some embodiments. In one example, a given user may have the option to either access the computing system 1302 via a client mobile device 1304 (such as a mobile phone operating either an application incorporating scheduling features described herein, or a browser accessing pages generated by the computing system 1302) or a client computing system 1303 (such as a laptop or other personal computer).

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm elements described in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached Figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A computer system comprising:
memory; and
a processor in communication with the memory and configured with processor-executable instructions to perform operations comprising:
receiving, over a network from a client computing device that includes a camera, an image of a deposition notice captured by the camera;
generating a meeting arrangement object for storage in the memory, wherein the meeting arrangement object includes a plurality of fields regarding a deposition, wherein the plurality of fields include at least a date, a time, a location, a plurality of participants, and a resource;
applying optical character recognition (OCR) to image data of at least a portion of the image to create text data represented in the image data;
searching the text data for each of a plurality of predefined keywords, wherein the plurality of predefined keywords each relate to one or more of the plurality of fields;
identifying, in the text data, a first keyword of the plurality of predefined keywords;
determining a first value for a first field of the plurality of fields based on a first text portion appearing near the first keyword in the text data, wherein the first value is different than the first keyword, and wherein the first value is determined based at least in part on applying at least one of pattern matching or natural language processing to the first text portion appearing near the first keyword in the text data;
determining a second value for a resource field of the plurality of fields based on a second text portion in the text data, wherein the second value indicates a resource required in the deposition, wherein the resource is associated with at least one of language translation, court reporting, or videotaping;
determining an additional participant for the deposition based on the resource required in the deposition, wherein the additional participant is not identified specifically in the text data or image data;
updating the meeting arrangement object to include at least (a) the first value for the first field and (b) the second value for the second field; and
generating and sending, over the network to one or more participants determined for the deposition, an electronic calendar invitation associated with the deposition.

2. The computer system of claim 1, wherein no user input is received by the computer system between receiving the image and updating the meeting arrangement object.

3. The computer system of claim 1, wherein the operations further comprise:
determining two or more potential physical locations for conducting the deposition based at least in part on location information identified in the text data; and
generating a user interface for display on the client computing device that (a) identifies each of the two or more potential physical locations and (b) enables a user of the client computing device to select one of the two or more physical locations as a location for the deposition.

4. The computer system of claim 1, wherein the operations further comprise determining a third value for a third field of the plurality of fields, wherein the third value is determined based on a corresponding value for a previous deposition that included a participant identified in the text data.

5. The computer system of claim 1, wherein the operations further comprise determining a value for at least one of the plurality of fields in the meeting arrangement object based at least in part on metadata associated with the image.

6. The computer system of claim 1, wherein the operations further comprise determining a type of legal proceeding associated with the deposition based on an automated analysis of the image and at least one rule set associated with a specific court or specific jurisdiction.

7. The computer system of claim 1, wherein the operations further comprise:
sending a notification of the deposition to the plurality of participants by at least one of: email, a private web-accessible inbox associated with a deposition scheduling service, a push notification, an SMS message, or an in-application message presented within a computer application associated with a deposition scheduling service,
wherein contact information for delivery of the notification to at least one of the plurality of participants is determined from the text data represented in the image data.

8. A computer-implemented method comprising:
obtaining an image of a document in association with a request to schedule a meeting involving a plurality of participants;
generating a meeting arrangement object in computer memory;
applying optical character recognition (OCR) to image data of at least a portion of the image to create text data represented in the image data;
identifying meeting arrangement related information in the text data, wherein the meeting arrangement related information is identified based on at least one of keyword analysis, pattern matching or natural language processing of the text data;
updating the meeting arrangement object to include a plurality of associated values determined from the meeting arrangement related information, wherein at least two or more meeting participants are identified in the plurality of associated values;
determining an additional participant at least in part by searching a database based at least in part on one of the plurality of associated values, wherein the additional participant is associated with a resource to be used in the meeting, and wherein the additional participant is not identified specifically in the text data or image data;
updating the meeting arrangement object to include the additional participant; and
sending an electronic calendar invitation for the meeting to one or more participants determined from the text data created from the image data.

9. The computer-implemented method of claim 8, wherein the additional participant is an interpreter or videographer.

10. The computer-implemented method of claim 8, wherein the document is a deposition notice, and wherein the meeting is a deposition in a legal proceeding.

11. The computer-implemented method of claim 8, wherein no user input is received between obtaining the image and updating the meeting arrangement object.

12. The computer-implemented method of claim 8, further comprising:
determining two or more potential physical locations for conducting the meeting based at least in part on location information identified in the text data; and
generating a user interface for display that (a) identifies each of the two or more potential physical locations and (b) enables a user to select one of the two or more physical locations as a location for the meeting.

13. The computer-implemented method of claim 8, further comprising determining a first resource required for the meeting based on a determination that the first resource was used in association with a previous meeting that included a participant identified in the text data.

14. The computer-implemented method of claim 8, wherein at least one of the plurality of associated values are further determined based at least in part on metadata associated with the image.

15. The computer-implemented method of claim 8, wherein the electronic calendar invitation is sent to an email address extracted from the text data represented in the image data.

16. A computer system comprising:
memory; and
a processor in communication with the memory and configured with processor-executable instructions to perform operations comprising:
obtaining an image of a document in association with a request to schedule a meeting involving a plurality of participants;
generating a meeting arrangement object in computer memory;
applying optical character recognition (OCR) to image data of at least a portion of the image to create text data represented in the image data;
identifying meeting arrangement related information in the text data, wherein the meeting arrangement related information is identified based on at least one of keyword analysis, pattern matching or natural language processing of the text data;
updating the meeting arrangement object to include a plurality of associated values determined from the meeting arrangement related information, wherein at least two or more meeting participants are identified in the plurality of associated values;
determining an additional participant at least in part by searching a database based at least in part on one of the plurality of associated values, wherein the additional participant is associated with a resource to be used in the meeting, and wherein the additional participant is not identified specifically in the text data or image data;
updating the meeting arrangement object to include the additional participant; and
sending an electronic calendar invitation for the meeting to one or more participants determined from the text data created from the image data.

17. The computer system of claim 16, wherein the operations further comprise:
determining a potential physical location for conducting the meeting based at least in part on location information identified in the text data; and
generating a user interface for display that enables a user to select at least the potential physical location as a location for the meeting.

18. The computer system of claim 16, wherein the electronic calendar invitation is sent to an email address extracted from the text data represented in the image data.

19. The computer system of claim 16, wherein the document is a deposition notice, and wherein the meeting is a deposition in a legal proceeding.

20. The computer system of claim 19, wherein the meeting arrangement related information identified in the text data based on at least one of keyword analysis, pattern matching or natural language processing of the text data comprises at least each of: a witness name, a court name, a case docket number, a deposition location, a name of counsel for a plaintiff, and a name of counsel for a defendant.
